(19) United States
(12) Patent Application Publication
(10) Pub. No.: US 2010/0142594 A1
(43) Pub. Date: Jun. 10, 2010

(54) METHOD OF PROCESSING AN RF SIGNAL

(76) Inventors: Andrew Thomas Yule, East Grinstead, West Sussex (GB); Ian Simmons, West Sussex (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/517,540

(22) PCT Filed: Dec. 3, 2007
(86) PCT No.: PCT/IB2007/054894

§ 371 Date: Feb. 5, 2010

(30) Foreign Application Priority Data
Dec. 4, 2006 (EP) 06125357.1

(51) Int. Cl. H04L 27/06; H04B 1/707; H01P 11/00

(52) U.S. Cl. 375/147; 375/340; 29/600; 375/E01.002

(57) ABSTRACT

A method of receiving and processing an RF signal comprises receiving (5) the RF signal; analogue processing the signal and providing a digital output to a digital signal processor, the digital output including an added identification code unique to an RF front end receiver hardware. Within the digital signal processor, the identification code is compared with a predetermined identification code or set of codes to determine if there is match. If there is a (10) match, the digital output is processed to provide data to the user, and if there is not a match, an error function is implemented. This method enables a software developer to make the system function only when there is a match between the hardware and the software. This makes copying the software as difficult as copying the hardware, because (15) copied software will not work with the incorrect hardware batch.

This invention relates to a method of processing an RF signal, for example a GPS signal.

The Article “Real-time software radio architectures for GPS receivers” by Akos et al. (GPS World, July 2001) discloses GPS software receivers in which the GPS signal processing is accomplished by means of a programmable micro-processor or digital signal processor as opposed to analogue or discrete hardware components. A simplified “GPS software receiver” is provided consisting of a GPS antenna and GPS RF front end receiver for GPS signal pre-processing (including filtering, amplification and frequency down-conversion) and analogue to digital conversion.

The GPS signal samples outputted from the GPS RF front end receiver can be fed in to a modern PC running appropriate GPS signal processing software to determine a position fix. The authors of this article have contemplated the GPS software receiver in the form a “plug-in” module, i.e. a “dongle” type device, which because of its simple architecture could be manufactured cheaply, thereby facilitating widespread adoption.

Of course, the GPS signal processing software which would reside on the PC is inherently cheap to replicate.

It has been proposed to arrange the processor in the GPS receiver to first encrypt the GPS signal samples and then transmit the encrypted GPS signal samples to an external device. This is intended to address the disadvantage with conventional GPS receiver devices of the plug-in type described above. Once such a GPS receiver device has become widely disseminated and the data format in which the GPS receiver device provides the GPS signal samples known, a user is free to employ alternative GPS signal processing software to determine a position fix and not necessarily that of or authorised by the provider of the GPS receiver device. The encryption ensures that such a GPS receiver device could only be used with authorised GPS signal processing software which is able to decrypt the GPS signals samples to determine a position fix.

This approach is described in WO2004/059337, and it means that specific software must be used with a particular receiver.

However, software “piracy” is a well known problem for the software industry as a whole, and there remains a need to prevent software piracy undermining the commercial viability of developing and providing the GPS software.

In particular, a problem encountered by companies wishing to sell or license software GPS receivers is that third parties can make copies of the software without paying the appropriate fees. This could be simple theft by a completely unauthorised party or the more subtle “3^{rd} shift problem”, whereby an authorised licensee of the software distributes more copies of the software than they are entitled to and therefore only paying for a fraction.

This is not a problem commonly encountered by conventional hardware GPS vendors, as copying a physical chip (or chips) is inherently far more difficult. The invention is thus of particular interest for so-called software GPS systems as described above.

The invention aims to provide a mechanism that prevents unauthorised copying of a software GPS product, thus protecting the business interests of the owner/developer.

According to the invention, there is provided a method of receiving and processing an RF signal providing data to a user having a mobile receiver, comprising:

within an RF front end receiver of the mobile receiver:
receiving the RF signal;
analogue processing the signal; and
providing a digital output including an added identification code unique to the RF front end receiver hardware;

providing the digital output to a digital signal processor; and

within the digital signal processor, comparing the identification code with a predetermined identification code or set of codes to determine if there is match, and if there is a match, further processing the digital output to provide the data to the user, and if there is not a match, implementing an error function.

This method enables a software developer to make the system function only when there is a match between the hardware and the software. This makes copying the software as difficult as copying the hardware, because copied software will not work with the incorrect hardware.

The analogue processing of the signal can comprise down converting to an intermediate frequency. The signal is converted to a digital signal, and the unique identifier is added.

Adding an identification code may comprise adding a code derived from a wafer position of a semiconductor IC of the RF front end receiver. Each IC can have a unique code (for example based on wafer/batch number and wafer position). In theory therefore, it is possible to have a one-to-one match of the hardware with the software.

However, it is sufficient for the software to be operable only for a particular variant of the RF front end receiver IC, and for the error message to arise for other variants. It is then easy to compare how many of this variant of the IC have been manufactured and sold compared to the number of software licences sold.

Implementing the error function can comprise providing an error message, operating with reduced functionality, or not processing the digital output.

The RF signal preferably comprises a spread spectrum signal received from a satellite based navigation system (such as GPS) and further processing the digital output is to provide navigation information.

The invention also provides a method of manufacturing an RF front end receiver, comprising:

fabricating an RF front end receiver with an embedded identification code unique to the RF front end receiver hardware, wherein the RF front end receiver is adapted to provide the identification code as part of its digital output to a digital signal processor, and wherein the embedded identification code is agreed with a software provider of the software to be implemented in the digital signal processor for processing the digital output.

By matching an identification code of the RF front end receiver hardware with the software provider, it becomes possible to track the sale of software licences with the sale of the hardware.

Thus, a method of manufacturing and monitoring an RF front end receiver, comprises manufacturing the RF front end receiver using this method, selling the RF front end receiver and notifying the software provider of the identity of the purchaser of the RF front end receiver.

The invention also provides a computer program comprising computer program code means adapted to analyse a digital signal comprising a digitally sampled signal corresponding to an RF signal for providing data to a user, and to which has been added an identification code unique to the hardware of an RF front end receiver, wherein the analysis comprises comparing the identification code with a predetermined identification code or set of codes to determine if there is match, and if there is a match, further processing the digital output to provide the data to the user, and if there is not a match implementing an error function.

The invention also provides an RF signal receiver, comprising:

an antenna for receiving an RF signal;

an RF front end receiver adapted to add an identification code unique to the RF front end receiver hardware and provide a digital output;

a digital signal processor which receives the digital output; and

software implemented within the digital signal processor and adapted to compare the identification code with a predetermined identification code or set of codes to determine if there is match, and if there is a match to further process the digital output to provide the data to the user, and if there is not a match to implement an error function.

The present invention will now be described, by way of example only, with reference to the accompanying schematic drawings in which:

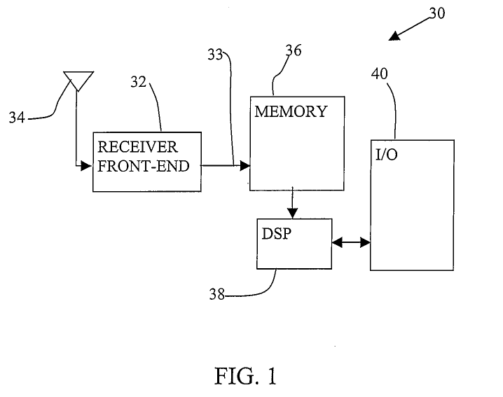

FIG. 1 shows a conventional GPS receiver architecture in schematic form;

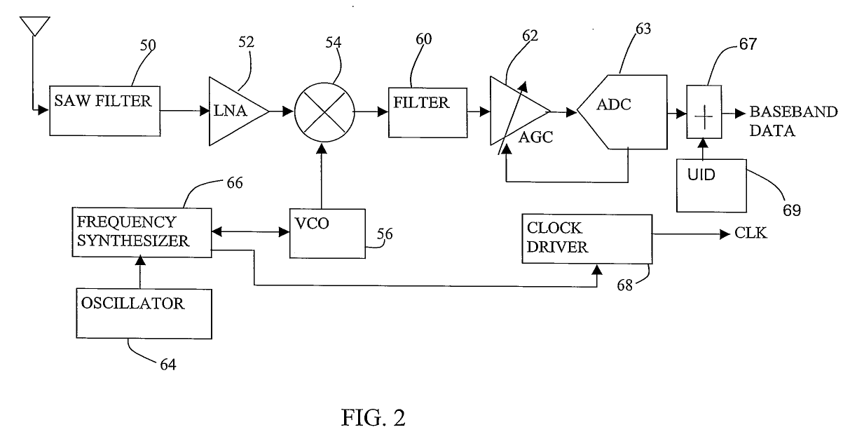

FIG. 2 shows the RF front end receiver in greater detail; and

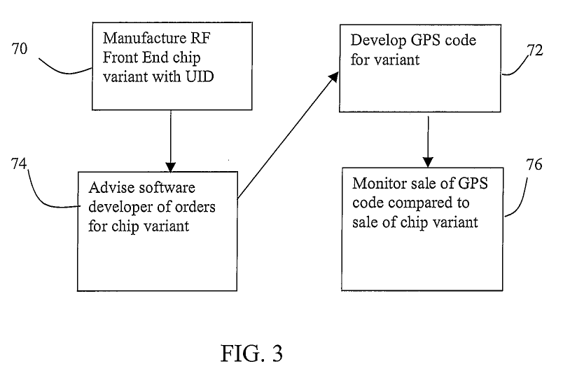

FIG. 3 is used to explain the method of the invention.

The invention relates to RF signal receivers generally, but is of particular interest for so-called “software GPS”, namely a GPS system in which all the data processing is implemented in software, with the received data stored in a memory buffer. This enables the real time link of the receiver to be broken, and reduces the amount of dedicated hardware required (such as correlators).

The basic architecture of a software GPS receiver 30 is represented in FIG. 1.

The receiver comprises a receiver front end 32, which receives the wireless signals using an antenna 34. The receiver front end 32 receives modulated RF signals from one or more satellites.

The received signal is amplified, filtered, down-converted, and digitized by the receiver front end 32 to produce a baseband signal 33 derived from the received signal, and in the form of digitised samples.

The digitised samples are provided to a memory buffer 36, and the data stored in the memory 36 is processed by a general purpose CPU i.e. a digital signal processor (DSP) 38. A user interface is provided by input/output system 40. The digitised samples are processed to extract the information and data from the satellite signals. The data samples are typically in the form of one or two bit data, and at a much higher analogue to digital sampling rate than the data rate of the signals received from the satellites.

The DSP 38 implements the functions of more conventional dedicated hardware systems, of correlation, multiplexing and Fourier transformations, in known manner.

FIG. 2 shows the RF front end receiver 32 in greater detail.

The signals received from the antenna are filtered by a surface acoustic wave (SAW) filter 50 before amplification by a low noise amplifier (LNA) 52. The signals are mixed at mixer 54 with the output of a voltage controlled oscillator (VCO) 56. This down converts the signals to baseband, where they are subjected to further filtering by filter 60 and amplification with automatic gain control (AGC) in the amplifier 62. Analogue to digital conversion takes place in converter 63, which also provides a feedback control for the AGC setting. The RF front end receiver also includes an oscillator 64 and frequency synthesizer 66 as shown, with the frequency synthesiser controlling a clock driver 68 to generate a clock signal CLK.

The invention concerns in particular the link between the RF front end receiver and the DSP, as shown by arrow 33 in FIG. 1, and the processing implemented in the DSP 38.

The invention provides an identification code unique to the RF front end receiver hardware at this interface, and this code can be validated in software in the DSP. Thus, the software can be tied to specific hardware. This means the ease of copying the software does not enable a functioning system to be implemented, as the copied software will not (or is unlikely to) match a different RF front end receiver hardware. Even if there is a match (because the software is only sensitive to a batch of RF front end receiver chips) a mismatch between hardware and software sales can then be detected.

FIG. 2 shows a UID added to data at the output of the analogue to digital converter 63, in data combiner 67, which is supplied with the UID from unit 69.

In a first aspect, the invention assumes that manufacturers of the RF front end chips used in the software GPS receivers are prepared to cooperate with the developers of the software GPS code.

In particular, this aspect of the invention requires the front end chip manufacturers to create a custom variant of the RF front end specifically for the software GPS developer. This doesn't mean the manufacturer will necessarily supply that variant to the software developer, but they will provide the software developer with the order size and purchaser of all orders of that variant.

All the RF front end chips will contain a unique identifier (“UID”), in such a way that no other front end (of any variant of the chip), will contain the same UID. The RF front end is then designed in such a way that, during normal operation, the UID is embedded into the intermediate frequency (“IF”) data stream output by the chip in a known manner.

The software developer is thus able to write the software GPS code in such a way that, during operation, it will extract the UID from the IF data stream and check that it is valid, and refuse to operate if not. This renders unauthorised copying unprofitable as the software developer can be told by the RF front end vendor of any additional chip sales.

The simplest form of the invention would involve a software GPS developer (“The Software Developer”) designing their software to run with a particular RF front end model number “RF Model N” made by a particular manufacturer “The Manufacturer”.

The design of the RF Model N is such that it contains for example a 64 bit UID “burnt in” by laser on the production line.

This UID can be made up of fields that include:
the position of the chip on the wafer;
the wafer number; and
a variant number (for example 8 bits).

The UID is therefore unique and no two chips will contain the same number.

A first variant can have the variant number set to 0 for all chips. The Software Developer can then agree with The Manufacturer to make a variant of the RF Model N, called the “RF Model N version 2” and that all such variants will be identical to the Model N, except that the 8 bit variant field will always be 1. The Manufacturer can then agree to make no other variants for which the variant field is also 1.

The RF front end receiver is designed in such a way that it periodically embeds the UID into the IF data stream it outputs when it is operating.

The Manufacturer also agrees to provide The Software Developer with details of all orders for the “RF Model N version 2” variant, including the size of order and identity of the purchaser.

The Software Developer can then develop a software GPS product and license it to a 3^{rd} party developer. The Software Developer then tells the 3^{rd} party developer that they need to use the “RF Model N version 2” in their design, and at run time the software is written in such a way as to extract the UID from the IF data stream it processes.

If the UID does not contain a variant field with the appropriate value (1 in this case), then the software will not operate correctly.

In this example, only the variant number needs to be analysed by the DSP. Of course, a particular variant number can be considered to equate to a set of UID codes.

This implementation provides software mapped to a chip model number or variant, and this may comprise many thousands of chips. It is equally possible to have finer control. For example the software can look for matches with any number of UIDs from one UID (i.e. matching one bespoke software to a single piece of hardware) to a batch of many thousands of chips.

The method by which the UID is embedded in the IF data stream could be as simple a inserting the full code (e.g. 64 bit) for example every 1024 bits, either by overwriting the IF data samples that would otherwise have been output or by actually inserting the code between adjacent IF samples. However the UID could also be spread out in the IF data stream—in the limit one bit at a time, inserted at intervals of for example 32 bits.

The methodology is shown in FIG. 3.

The Manufacturer carries out the steps of manufacturing the chip (step 70) with the embedded UID, which has been agreed with The Software Developer. In parallel, the GPS code is developed (step 72) for the particular variant having the agreed batch of UIDs. After sale of the hardware, The Manufacturer continues to advise The Software Developer about the sales of the variant (step 74) and The Software Developer monitors the sale or licence of the GPS code (step 76), which should match the chip sales.

As mentioned above, The Manufacturer can provide The Software Developer with detailed information of the precise UIDs supplied to each customer who orders the “RF Model N version 2”, thus allowing The Software Developer to make variants of their software that are specifically linked to the UIDs purchased by a specific customer or customers.

In the case where an invalid UID or no UID is detected by the software, a number of possibilities are available:
simply stopping;
reporting an error message to the user; and
operating with degrade performance (with or without a message to the user).

The UID could include some form of cyclic redundancy check or indeed encryption to make it harder to fake.

The manner in which the UID is embedded could be controlled by the software (by sending appropriate control signals to the front end). This could include changing the period, number of bits at a time, turning off completely, only inserting it once on request, whether true insertion or overwriting is used. All of this would make it harder for third parties to “break” the scheme.

The chips could also include an EEPROM that would allow the code embedded in the IF stream to be augmented or replaced by a code uploaded at run-time into the front end. This feature could be used in association with some form of “registration” (for example with an online server run by The Software Developer) in which the UID is submitted and if valid, an encrypted code based on the UID is returned.

The software GPS code would, in this case, be written so as to only function fully, if both a legal UID and matching encrypted code were visible. This option is particular relevant if The Manufacturer can't or won't provide either a custom variant or sufficient details of purchased chips, as it allows The Software Developer to secure their software on the UID without any previous knowledge of the UID.

The system of the invention allows protection for software linked with the software forming the software GPS code, for example navigation applications and the maps used.

The benefits of known software GPS systems can all be obtained in the system of the invention. For example, the system of the invention can be used for live processing of the sampled GPS data, as soon as it is available from the memory buffer, or the processing may take place later and also possibly at a different location. Thus, the receiver may not include all of the processing capability for interpreting the GPS data.

The invention has been described above in connection with software

GPS, but it could equally apply to other navigation systems and/or other software radios. The invention is thus also equally applicable to the Galileo navigation system currently under development.

It is noted that the manufacture and sale of chips that include unique IDs (UIDs) is well known, for example for EEPROM chips, and the provision of a UID will therefore be routine to those skilled in the art.

From a reading of the present disclosure, other modifications will be apparent to the skilled person and may involve other features which are already known in the design, manufacture and use of GPS receivers and component parts thereof and which may be used instead of or in addition to features already described herein.

1. A method of receiving and processing an RF signal providing data to a user having a mobile receiver, comprising:
within an RF front end receiver of the mobile receiver:
receiving the RF signal;
analogue processing the signal; and
providing a digital output including an added identification code unique to the RF front end receiver hardware;
providing the digital output to a digital signal processor; and
within the digital signal processor, comparing the identification code with a predetermined identification code or set of codes to determine if there is match, and if there is a match, further processing the digital output to provide the data to the user, and if there is not a match, implementing an error function.

2. A method as claimed in claim 1, wherein analogue processing the signal comprises down converting to an intermediate frequency.

3. A method as claimed in any preceding claim, wherein adding an identification code comprises adding a code derived from a wafer position of a semiconductor IC of the RF front end receiver.

4. A method as claimed in claim 3, wherein adding an identification code comprises adding a code derived from a batch number of the semiconductor IC.

5. A method as claimed in any preceding claim, wherein implementing the error function comprises providing an error message, operating with reduced functionality, or not processing the digital output.

6. A method as claimed in any preceding claim, wherein the RF signal comprises a spread spectrum signal received from a satellite based positioning system and wherein further processing the digital output is to provide navigation information.

7. A method of manufacturing an RF front end receiver, comprising:
fabricating an RF front end receiver (32) with an embedded identification code unique to the RF front end receiver hardware, wherein the RF front end receiver is adapted to provide the identification code as part of its digital output to a digital signal processor, and wherein the embedded identification code is agreed with a software provider of the software to be implemented in the digital signal processor for processing the digital output.

8. A method as claimed in claim 7 of manufacturing an RF front end receiver for receiving a spread spectrum signal from a satellite based positioning system.

9. A method of manufacturing and monitoring an RF front end receiver, comprising:
manufacturing the RF front end receiver (32) using the method of claim 7 or 8;
selling the RF front end receiver; and
notifying the software provider of the identity of the purchaser of the RF front end receiver.

10. A computer program comprising computer program code means adapted to analyse a digital signal comprising a digitally sampled signal corresponding to an RF signal for providing data to a user and to which has been added an identification code unique to the hardware of an RF front end receiver, wherein the analysis comprises comparing the identification code with a predetermined identification code or set of codes to determine if there is match, and if there is a match, further processing the digital output to provide the data to the user, and if there is not a match implementing an error function.

11. An RF signal receiver, comprising:
an antenna for receiving an RF signal;
an RF front end receiver (32) adapted to add an identification code unique to the RF front end receiver hardware and provide a digital output;
a digital signal processor (38) which receives the digital output; and
software implemented within the digital signal processor and adapted to compare the identification code with a predetermined identification code or set of codes to determine if there is match, and if there is a match to further process the digital output to provide the data to the user, and if there is not a match to implement an error function.

12. A receiver as claimed in claim 11, wherein the RF front end receiver is adapted to down convert the RF signal to an intermediate frequency.

13. A receiver as claimed in claim 11 or 12, the identification code comprises a code derived from a wafer position of a semiconductor IC of the RF front end receiver.

14. A receiver as claimed in claim 13, the identification code comprises a code derived from a wafer batch number of the semiconductor IC.

15. A receiver as claimed in any one of claims 11 to 14, wherein the error function comprises an error message, a mode of operation with reduced functionality, or a function to not process the digital output.

16. A receiver as claimed in any one of claims 11 to 15 for receiving a spread spectrum signal received from a satellite based navigation system and wherein the data comprises navigation information.
